(19) United States
(12) Patent Application Publication
(10) Pub. No.: US 2017/0025969 A1
(43) Pub. Date: Jan. 26, 2017

(54) SYNCHRONOUS RECTIFIER PHASE CONTROL TO IMPROVE LOAD EFFICIENCY

(71) Applicant: TEXAS INSTRUMENTS INCORPORATED, DALLAS, TX (US)

(72) Inventors: SHANGUANG XU, PLANO, TX (US); BRENT A. MCDONALD, MURPHY, TX (US)

(21) Appl. No.: 15/204,631

(22) Filed: Jul. 7, 2016

Related U.S. Application Data
(60) Provisional application No. 62/195,555, filed on Jul. 22, 2015.

(51) Int. Cl. H02M 7/217; H02M 1/08

(52) U.S. Cl. CPC H02M 7/217; H02M 1/08; H02M 2001/0009

(57) ABSTRACT

A semiconductor device includes a current monitor circuit to measure a load current. A controller controls drive signals having a signal phase to operate a synchronous rectifier (SR) circuit based on the measured load current from the current monitor circuit. The controller applies a first control phase sequence to control the signal phase to the SR circuit if the measured load current is above a predetermined current threshold. The controller applies a second control phase sequence to control the signal phase to the SR circuit if the measured load current is equal or below the predetermined current threshold.

### CROSS-REFERENCE TO RELATED APPLICATION

This application claims the benefit of U.S. Provisional Patent Application 62/195555, filed on 22 Jul. 2015, and entitled A NOVEL SYNCHRONOUS RECTIFIER CONTROL TO IMPROVE LIGHT LOAD AND MEDIUM LOAD EFFICIENCY FOR A PHASE-SHIFT FULL-BRIDGE CONVERTER, the entirety of which is incorporated by reference herein.

### TECHNICAL FIELD

This disclosure relates to power supply circuits and more particularly to a control circuit to improve efficiency of a synchronous rectifier output circuit based on load conditions.

### BACKGROUND

A phase-shift full-bridge (PSFB) converter has been utilized for many years to perform power conversions from one level to another. The PSFB can realize soft-switching of power switches of the converter where such switches can be operated by a digital controller, for example. The PFSB can reduce switching losses and hence it can increase power efficiency. This circuit topology has been widely used in telecom rectifiers, server power supplies, and so forth. When synchronous metallic oxide semiconductor field effect transistor (SyncFETs) are adopted to replace rectifier diodes in the secondary side of the converter, the converter efficiency can be further improved. However, in a traditional PSFB converter, it has been found that when load current is small, power efficiency may be decreased if the SyncFETs are turned on. This is due to reverse current to cause more power losses and higher switching loss on the primary side of the converter. If the SyncFETS are completely turned off, power efficiency may be decreased as well due to the large voltage drop from body diodes of the SyncFETs.

### SUMMARY

This disclosure relates to a control circuit to improve efficiency of a synchronous rectifier output circuit based on load conditions. In one example, a semiconductor device includes a current monitor circuit to measure a load current. A controller controls drive signals having a signal phase to operate a synchronous rectifier (SR) circuit based on the measured load current from the current monitor circuit. The controller applies a first control phase sequence to control the signal phase to the SR circuit if the measured load current is above a predetermined current threshold. The controller applies a second control phase sequence to control the signal phase to the SR circuit if the measured load current is equal or below the predetermined current threshold.

In another example, a circuit includes a first transistor switch device and a second transistor switch device that operate as synchronous rectifier (SR) circuit to rectify an alternating current (AC) output voltage from a transformer to drive a load current to a load. A current monitor circuit measures the load current. A controller controls a signal phase applied to the first and the second transistor devices to operate the SR circuit based on the measured load current from the current monitor circuit. The controller applies a first control phase sequence to control the signal phase if the measured load current is above a predetermined current threshold. The controller applies a second control phase sequence to control the signal phase if the measured load current is equal or below the predetermined current threshold. The second control phase sequence turns off each of the first and second transistor devices if the output voltage from the transformer is turned off.

In yet another example, a method includes measuring a load current in a synchronous rectifier (SR) circuit. The method includes controlling a signal phase to operate the SR circuit based on the measured load current. The method includes applying a first control phase sequence to control the signal phase to the SR circuit if the measured load current is above a predetermined current threshold. The method includes applying a second control phase sequence to control the signal phase to the SR circuit if the measured load current is equal or below the predetermined current threshold.

### BRIEF DESCRIPTION OF THE DRAWINGS

FIG. 1 illustrates a schematic block diagram of an example circuit to improve power efficiency of a synchronous rectifier output circuit based on load conditions.

FIG. 2 illustrates an example phase-shift full bridge power converter having a synchronous rectifier output circuit that can be controlled based on load conditions.

FIG. 3 illustrates an example controller circuit to control a synchronous rectifier output circuit based on load conditions.

FIG. 4 illustrates an example signal diagram to control a synchronous rectifier output circuit when current load is above a predetermined current threshold.

FIG. 5 illustrates an example signal diagram to control a synchronous rectifier output circuit when current load is equal or below a predetermined current threshold.

FIG. 6 illustrates a flow diagram of an example method to improve efficiency of a synchronous rectifier output circuit based on load conditions.

### DETAILED DESCRIPTION

This disclosure relates to a control circuit to improve efficiency of a synchronous rectifier output circuit based on load conditions. Load current at the output of a power converter (e.g., a phase-shift full-bridge (PSFB) converter) can be monitored to determine transition points between lighter and heavier current loads where one type of control signal phasing can be employed at lighter loads to improve efficiency for such loads and a second type of control signal phasing can be employed for heavier loads which increases efficiency for higher current outputs of the converter. The control signal phasing can be applied to each transistor device operating as a synchronous rectifier (SR) circuit operating at the output stage of the converter. For instance, the SR circuit can include a first transistor switch device and a second transistor switch device to rectify an alternating current (AC) output voltage from a transformer which in turn drives a load current to a load at the output of the converter. A current monitor circuit (e.g., current amplifier and analog to digital converter (ADC)) measures the load current. A controller controls a signal phase applied to the first and the second transistor devices to operate the SR circuit based on the measured load current. The controller applies a first control phase sequence to control the signal phase if the measured load current is above a predetermined current threshold. Under these heavier load conditions, the first control sequence can be utilized to improve efficiency. Under lighter load conditions, the controller applies a second control phase sequence to control the signal phase if the measured load current is equal or below the predetermined current threshold to improve efficiency. Thus, the controller can dynamically switch between one control signal and phase sequence to another to improve SR efficiency under varying load conditions.

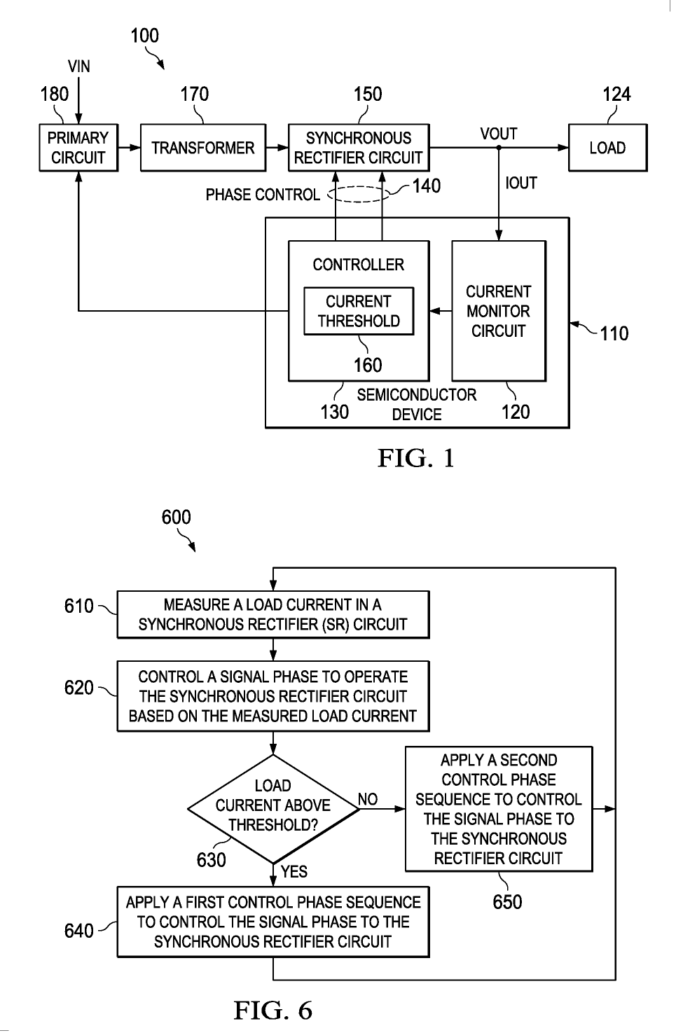

FIG. 1 illustrates an example semiconductor device 100 to improve efficiency of a synchronous rectifier output circuit based on load conditions. As used herein, the term circuit can include a collection of active and/or passive elements that perform a circuit function such as an analog circuit or control circuit, for example. Additionally or alternatively, the term circuit can include an integrated circuit where all and/or some of the circuit elements are fabricated on a common substrate, for example.

As shown in the example of FIG. 1, the circuit 100 includes a semiconductor device 110 that include a current monitor circuit 120 to measure a load current IOUT to a load 124. A controller 130 controls drive signals 140 having a signal phase to operate a synchronous rectifier (SR) circuit 150 based on the measured load current from the current monitor circuit 120. The controller 130 applies a first control phase sequence to control the signal phase to the SR circuit 150 if the measured load current is above a predetermined current threshold 160. As used herein, the term phase sequence represents an on/off state of each of the drive signals 140 with respect to each other.

In some cases, one drive signal 140 may be on while the other is off and in some cases both signals may be on or both signals off. The current threshold 160 can be an analog or digital value stored in the controller that is used to determine if the measure load current IOUT is above or below the threshold. The controller 130 applies a second control phase sequence to control the signal phase to the SR circuit 150 if the measured load current is equal or below the predetermined current threshold. Depending on detected load current conditions by the current monitor circuit 120, the efficiency of the circuit 100 can be dynamically controlled and optimized via the phase sequence of the drive signals 140 applied to the SR circuit 150.

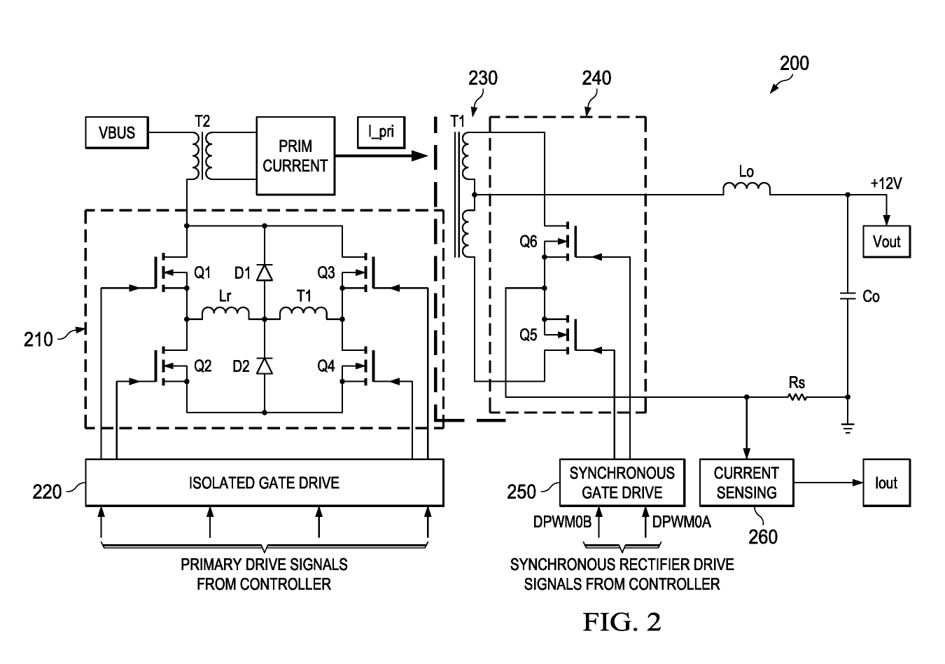

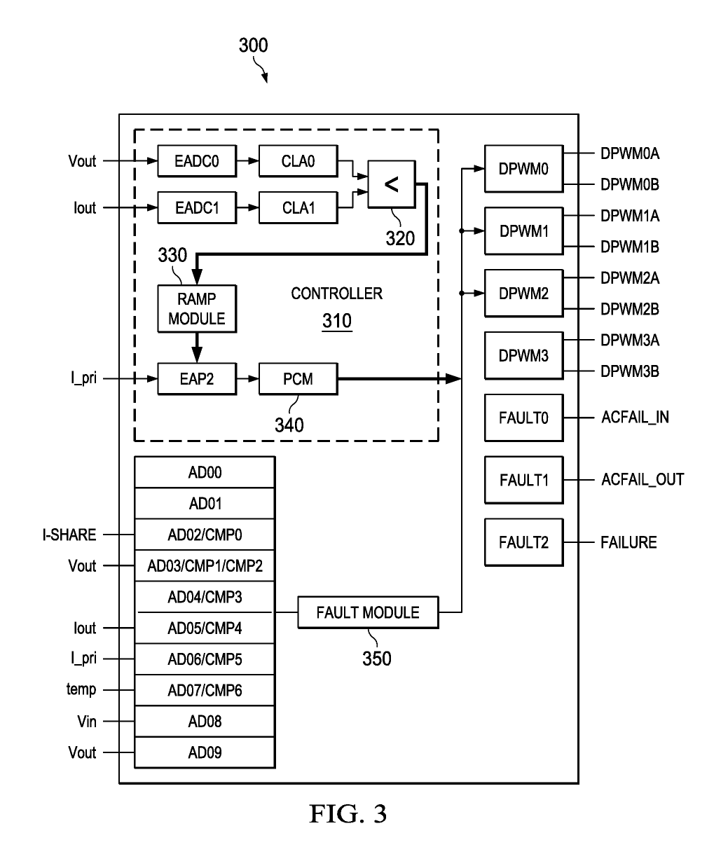

The current monitor circuit 120 can include a current amplifier, a Hall sensor, or a sense resistor to measure the load current IOUT, for example. The controller 130 can include an analog to digital converter (ADC) (or converters See e.g., FIG. 3) to determine a value of the load current with respect to the predetermined current threshold 160. A first transistor switch device and a second transistor switch device can operate in the SR circuit 150 (See e.g., FIG. 2) to rectify an alternating current (AC) output voltage from a transformer 170 to drive the load current IOUT provide load output voltage VOUT to the load 124. The drive signals 140 from the controller 130 can be driven via a gate driver circuit to inputs of the first and second transistor devices in the SR circuit 150.

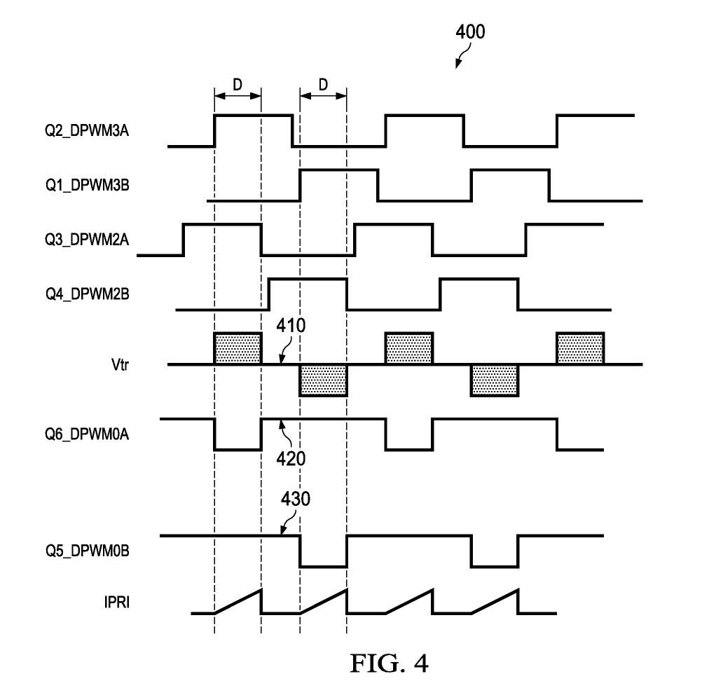

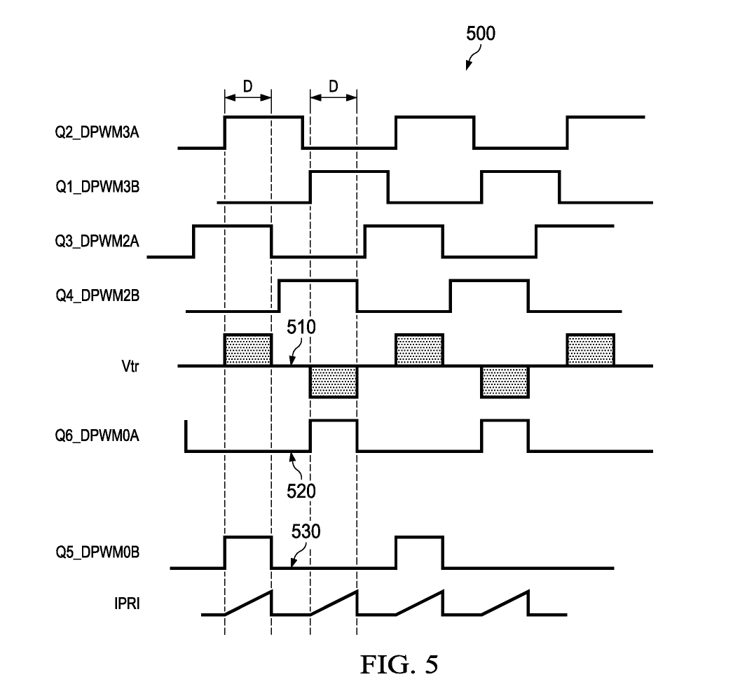

Under lighter load conditions, the second control phase sequence from the controller turns off each of the first and second transistor devices in the SR circuit 150 if the output voltage from the transformer 170 is turned off (e.g., transformer not being driven on the primary side). Under these conditions, the second control phase from the controller 130 pulses the second transistor device on in the SR circuit 150 only if the output from the transformer 170 is positive. During the second control phase from the controller 150, the controller pulses the first transistor device on only if the output from the transformer is negative. Such control sequencing and phasing for the drive and other signals described herein is illustrated below with respect to the signal diagrams of FIGS. 4 and 5.

A primary side switching circuit 180 drives the transformer 180 with respect to input voltage VIN. As shown, the primary side switching circuit 180 is operated by the controller 130. In one example, the primary side switching circuit 180 and the SR circuit 150 are configured as a phase-shift full bridge power converter. The predetermined current threshold for switching between the first and second control phase sequence described herein can be set to about twenty amperes, for example, although other threshold settings are possible.

Power efficiency of a power converter such as the circuit 100 has been significantly improved due to the improved performances of power devices and control methods. For instance, power MOSFETS in the SR circuit 150 have much lower RDSON to reduce power conduction losses, and smaller parasitic capacitance can allow higher switching frequency but lower switching losses. The low MOSFET thermal resistance can transfer heat from the junction to the switch device case faster so that the devices can conduct more current. These improvements increase power efficiency as well as power density. The adoption of synchronous rectifiers in the SR circuit 150 provides high power density and high power efficiency, especially at large load current. The usage of a digital controller 130 adds more control flexibility and it can further reduce power losses since a digital controller can optimize switching frequency, dead-time, auto tuning, output voltage change, and so forth.

When power MOSFETs are used for synchronous rectifiers in a phase-shift full-bridge DC/DC converter, if the load current is less than the threshold of discontinuous conduction mode (DCM), the inductor current in the SR circuit 150 can drive negative. For instance, the negative current produces extra circulating losses, and can cause voltage spikes on the synchronous MOSFETs (syncFETs) in the SR circuit 150. In the meantime, the negative current can cause hard switching of the primary side MOSFETs in the primary circuit 180, which can further reduce power efficiency of the circuit 100. It is challenging to utilize all energy stored in the leakage inductor or resonant inductor. On the other hand, the power efficiency should be maintained as a traditional PSFB converter at large load current values. The control of synchronous MOSFETs as described herein based on measured load current and signal phases increases the efficiency of the circuit 100 over static control methods which do not vary the signal phases based on load.

FIG. 2 illustrates an example phase-shift full bridge power converter 200 having a synchronous rectifier output circuit that can be controlled based on load conditions. The example power converter 200 is but one specific example of the circuit 100 described above with respect to FIG. 1. In this example, an input voltage shown as VBUS drives a current transformer T2 in conjunction with a primary side switching circuit 210. Output from T2 is utilized to generate a primary current I_PRI utilized in part for controlling the circuit 200. The primary side switching circuit 210 includes a transformer primary T1 that is in series with inductance Lr and driven via transistors Q1, Q2, Q3, and Q4. Common connections between Q1 and Q3 are connected to the cathode of D1 which is connected in series via anode of D1 to the cathode of D2. The anode of D2 is connected to the common connection of Q2 and Q4. The primary side circuit 210 is driven via four primary drive signals from a controller via isolated gate driver 220.

As the primary side circuit 210 switches, transformer action of T1 generates an output alternating current (AC) voltage at a secondary 230 of T1. The AC voltage at the Ti secondary is synchronously rectified via first and second drive transistors Q5 and Q6 in an SR circuit 240. As shown, SR drive signals DPWM0A and DPWM0B from a controller are driven via gate driver 240. The SR drive signals control the turn-on and turn-off synchronous rectifier action of the transistors Q5 and Q6. By controlling the phasing of the SR drive signals based on measured load conditions as described herein, power efficiency of the SR circuit 240 can be improved. Output from a center tap connection of T1 is coupled to series inductor LO which provides output voltage VO across output capacitor CO. A series sense resistor RS and/or a current sensing amplifier 260 can be used to detect load current IOUT which can be measured via a controller such as shown in the example of FIG. 3. The current IOUT can be digitized and compared to a predetermined current threshold to generate the first and second phase control sequences described herein based on load conditions.

FIG. 3 illustrates an example of a controller circuit 300 to control a synchronous rectifier output circuit based on load conditions. The controller circuit 300 includes output circuits DPWM0 though DPWM 4. The circuit DPWM0 generates SR drive signals DPWM0A and DPWM0B previously described with respect to FIG. 2. The circuits DPWM2 and DPWM3 generate the primary drive signals described herein. Additional output circuits may be provided for status such as fault status FAULT0 though FAULT2, for example. A controller 310 includes error ADC's EADC0 and EADC1 which measure output voltage VOUT and load current IOUT. The controller 310 can include control logic circuits CLA0 and CLA1 which take output from EADC0 and EADC 1 and provide the output to a combining node 320.

Output from node 320 can be fed to a ramp module 330 which drives an error amplifier module EAP2 which also receives primary current I_PRI. Output from the error amplifier is processed through a phase control module (PCM) 340 which drives the output circuits DPMW0 through DPWM3. The control circuit 300 can also include additional ADC inputs shown as ADC00 though ADC09. In some examples, the ADC's can be combined with a threshold comparator to generate a flag based on the detected ADC values. Output from the ADC's can be provided to a fault detection module 350 to notify other circuits of detected faults based on received analog values. Such faults can be enabled or disabled via digital commands, for example.

FIG. 4 illustrates an example signal diagram 400 to control a synchronous rectifier output circuit when current load is above a predetermined current threshold as described herein. Under high current load conditions, the example signal phase and control timing described herein shown at 400 can be employed to maximize SR circuit efficiency. The first four signals on the diagram 400 represent primary side drive signals for drive transistors Q1, Q2, Q3, and Q4 shown in FIG. 2. The next signal on the diagram 400 is VTR which represents the secondary side output voltage at the secondary of the transformer T1 shown in FIG. 2. In some cases, the voltage VTR is positive, in some case the voltage VTR is negative, and in other cases, the VTR is turned off and at substantially zero volts. The next signals on the diagram 400 represent the SR drive signals outputs which drive Q6 and Q5 from FIG. 2 respectively. The signal IPRI is a ramp signal representing the primary current measured by the current transformer T2 shown in FIG. 2.

Note that when VTR is off at 410, both Q5 and Q6 output is turned on as shown at 420 and 430. Under high load conditions, it is more efficient to have these transistors turned on when VTR is essentially zero such as shown at 410. However, under lighter load conditions, conventional control schemes would continue to use the phase diagram 400 which would not be as efficient. Under detected lighter load conditions, the phase and timing diagram depicted in FIG. 5 can be employed.

FIG. 5 illustrates an example signal diagram 500 to control a synchronous rectifier output circuit when current load is equal or below a predetermined current threshold. Under lower current load conditions, the example signal phase and control timing described herein shown at 500 can be employed to increase SR circuit efficiency. The first four signals on the diagram 500 represent primary side drive signals for driving transistors Q1, Q2, Q3, and Q4 shown in FIG. 2. The next signal on the diagram 500 is VTR which represents the secondary side output voltage at the secondary of the transformer T1 shown in FIG. 2. As noted above, in some cases, the voltage VTR is positive, in some case the voltage VTR is negative, and in other cases, the VTR is turned off and at substantially zero volts. The next signals on the diagram 500 represent the SR drive signals outputs which drive Q6 and Q5 from FIG. 2 respectively. The signal IPRI is a ramp signal representing the primary current measured by the current transformer T2 shown in FIG. 2.

In this timing and phase example, when VTR is off at 510, both Q5 and Q6 output is turned off as shown at 520 and 530. Note that the only time Q6 is on is when VTR is negative and the only time Q5 is on is when VTR is positive. All other times both 05 and 06 are off. Thus, under low load current conditions, it is more efficient to have these transistors Q5 and Q6 turned off when VTR is essentially zero such as shown at 510.

In view of the foregoing structural and functional features described above, an example method will be better appreciated with reference to FIG. 6. While, for purposes of simplicity of explanation, the method is shown and described as executing serially, it is to be understood and appreciated that the method is not limited by the illustrated order, as parts of the method could occur in different orders and/or concurrently from that shown and described herein. Such methods can be executed by various components configured in an integrated circuit, processor, or a controller, for example.

FIG. 6 illustrates an example method 600 to improve efficiency of a synchronous rectifier output circuit based on load conditions. At 600, the method 600 includes measuring a load current in a synchronous rectifier (SR) circuit (e.g., via current monitor circuit 120 of FIG. 1). At 630, the method 600 includes controlling a signal phase to operate the SR circuit based on the measured load current (e.g., via controller 130 of FIG. 1). At 630, the method 600 determines whether the measured load current is above a predetermined threshold. If so, the method 600 proceeds to 640 and applies a first control phase sequence to control the signal phase to the SR circuit if the measured load current is above the predetermined current threshold (e.g., via controller 130 of FIG. 1). The method 600 then proceeds back to 610 after 640.

If the measured current is equal or below the threshold at 630, the method 600 proceeds to 650 and applies a second control phase sequence to control the signal phase to the SR circuit if the measured load current is equal or below the predetermined current threshold (e.g., via controller 130 of FIG. 1). The method 600 then proceeds back to 610 after 650. The method 600 can also include turning off each of a first and a second transistor device in the SR circuit if an output voltage driving the SR circuit is off. This can include pulsing the second transistor device on only if the output voltage driving the SR circuit is positive. Also, the method 600 can include pulsing the first transistor device on only if the output voltage driving the SR circuits is negative.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A semiconductor device comprising:
a current monitor circuit to measure a load current; and
a controller to control drive signals having a signal phase to operate a synchronous rectifier (SR) circuit based on the measured load current from the current monitor circuit, the controller applies a first control phase sequence to control the signal phase to the SR circuit if the measured load current is above a predetermined current threshold and applies a second control phase sequence to control the signal phase to the SR circuit if the measured load current is equal or below the predetermined current threshold.

2. The semiconductor device of claim 1, wherein the current monitor circuit includes a current amplifier, a Hall sensor, or a sense resistor to measure the load current.

3. The semiconductor device of claim 1, wherein the controller includes an analog to digital converter (ADC) to determine a value of the load current with respect to the predetermined current threshold.

4. The semiconductor device of claim 1, further comprising a first transistor switch device and a second transistor switch device that operate in the SR circuit to rectify an alternating current (AC) output voltage from a transformer to drive the load current to a load.

5. The semiconductor device of claim 4, wherein the drive signals from the controller are driven via a gate driver circuit to inputs of the first and second transistor devices.

6. The semiconductor device of claim 4, wherein the second control phase sequence turns off each of the first and second transistor devices if the output voltage from the transformer is turned off.

7. The semiconductor device of claim 6, wherein the second control phase pulses the second transistor device on only if the output from the transformer is positive.

8. The semiconductor device of claim 6, wherein the second control phase pulses the first transistor device on only if the output from the transformer is negative.

9. The semiconductor device of claim 4, further comprising a primary side switching circuit to drive the transformer, wherein the primary side switching circuit is operated by the controller.

10. The semiconductor device of claim 9, wherein the primary side switching circuit and the SR circuit are configured as a phase-shift full bridge power converter.

11. The semiconductor device of claim 1, wherein the predetermined current threshold is set to about twenty amperes.

12. A circuit comprising:
a first transistor switch device and a second transistor switch device that operate as synchronous rectifier (SR) circuit to rectify an alternating current (AC) output voltage from a transformer to drive a load current to a load;
a current monitor circuit to measure the load current; and
a controller to control a signal phase applied to the first and the second transistor devices to operate the SR circuit based on the measured load current from the current monitor circuit, the controller applies a first control phase sequence to control the signal phase if the measured load current is above a predetermined current threshold and applies a second control phase sequence to control the signal phase if the measured load current is equal or below the predetermined current threshold, the second control phase sequence turns off each of the first and second transistor devices if the output voltage from the transformer is turned off.

13. The circuit of claim 12, wherein the second control phase pulses the second transistor device on only if the output from the transformer is positive.

14. The circuit of claim 12, wherein the second control phase pulses the first transistor device on only if the output from the transformer is negative.

15. The circuit of claim 12, further comprising a primary side switching circuit to drive the transformer, the primary side switching circuit operated by the controller.

16. The circuit of claim 15, wherein the primary side switching circuit and the SR circuit are configured as a phase-shift full bridge power converter.

17. A method comprising:
measuring a load current in a synchronous rectifier (SR) circuit via a controller;
controlling a signal phase, via the controller, to operate the SR circuit based on the measured load current;
applying a first control phase sequence, via the controller, to control the signal phase to the SR circuit if the measured load current is above a predetermined current threshold; and
applying a second control phase sequence, via the controller, to control the signal phase to the SR circuit if the measured load current is equal or below the predetermined current threshold.

18. The method of claim 17, further comprising turning off each of a first and a second transistor device in the SR circuit, via the controller, if an output voltage driving the SR circuit is off.

19. The method of claim 18, further comprising pulsing the second transistor device on, via the controller, only if the output voltage driving the SR circuit is positive.

20. The method of claim 18, further comprising pulsing the first transistor device on, via the controller, only if the output voltage driving the SR circuits is negative.
